(19) United States
(12) Patent Application Publication
(10) Pub. No.: US 2009/0255359 A1
(43) Pub. Date: Oct. 15, 2009

(54) ROTATIONAL DRIVE TRANSMISSION MECHANISM AND IMAGE FORMING APPARATUS USING THE SAME

(76) Inventors: Tetsushi ITO, Nara-shi (JP); Yoshikazu Harada, Nara-shi (JP); Norio Tomita, Nara-shi (JP); Noriaki Taguchi, Ikoma-gun (JP); Shuichi Mochizuki, Yamatokoriyama-shi (JP)

Correspondence Address: NIXON & VANDERHYE, PC, 901 NORTH GLEBE ROAD, 11TH FLOOR, ARLINGTON, VA, 22203, US

(21) Appl. No.: 12/413,693

(22) Filed: Mar. 30, 2009

(30) Foreign Application Priority Data
Apr. 11, 2008 (JP) 2008-103778

(51) Int. Cl. F16H 55/08; G03G 15/00

(52) U.S. Cl. 74/462; 399/167

(57) ABSTRACT

A rotational drive transmission mechanism used in an image forming apparatus for transmitting rotational drive force using an internal gear and an external gear having involute tooth profiles, includes photoreceptor drum drive couplings for transmitting rotational drive force to photoreceptor drums and a transfer drive coupling for transmitting rotational drive force to an intermediate transfer belt drive roller. The internal gears provided for these are so formed that all the drive vectors of the rotational drive force transmitted to the teeth of either the internal gear or the external gear in mesh with the internal gear, are made uniform so as to be oriented either outwards from the center of the rotational axis or inwards toward the center of the rotational axis, equivalently relative to the center of the rotational axis.

This Nonprovisional application claims priority under 35 U.S.C. §119(a) on Patent Application No. 2008-103778 filed in Japan on 11 Apr. 2008, the entire contents of which are hereby incorporated by reference.

### BACKGROUND OF THE INVENTION

(1) Field of the Invention

The present invention relates to a rotational drive transmission mechanism and an image forming apparatus inducing this, in particular relating to a rotational drive transmission mechanism for transmitting rotational drive force using an internal gear and an external gear having involute tooth profiles as well as to an image forming apparatus including the rotational drive transmission mechanism.

(2) Description of the Prior Art

In the conventional image forming apparatuses based on electrophotography such as facsimile machines, printers and the like, image forming is performed by electrifying a rotationally driven photoreceptor drum by a charger, illuminating the photoreceptor drum with light in accordance with image information to form an electrostatic latent image, and applying toner to this electrostatic latent image by a developing unit to form a toner image. This toner image is transferred to a recording medium such as sheet material, paper, etc., to produce an image printout.

In the thus constructed image forming apparatus, a drive transmission mechanism including gear transmission devices, coupling devices and the like is usually used to transfer drive from the rotational drive source of the apparatus body to each operating unit.

In particular, the drives for the photoreceptor drum and transfer portion need drive transmission free from rotational irregularity. However, conventionally there has been the problem that slight play and backlash in the drive transmission mechanism causes rotational irregularity and positional deviations of the axial direction of extension of the photoreceptor drum.

As the countermeasures against the above problem, there has been a disclosed configuration in which an internal gear is adopted as the drive transmission mechanism for a photoreceptor drum to rotate the photoreceptor drum without rotational irregularity (see patent document 1: Japanese Patent Application Laid-open 2002-341696).

However, in the drive transmission mechanism based on the so-called internal gear system using the aforementioned internal gear, as shown in FIG. 1, a driven body 3× such as a photoreceptor drum etc., tends to deviate (wobble) 3c with respect to the center O of its rotational axis, this posing the problem of producing adverse influence on quality of printed images.

Further, it has turned out that, with the conventional internal gear, as shown in FIG. 1, depending on the contact point between the tooth of the gear on the drive source side and the tooth of the gear on the driven body 3× side, some teeth receive drive vectors directed towards the center of the rotational axis while other teeth receive drive vectors directed outwards from the center of the rotational axis, causing a wobble of driven body 3× about the center O.

### SUMMARY OF THE INVENTION

The present invention has been devised in view of the above configuration problems, it is therefore an object of the present invention to provide a rotational drive transmission mechanism and an image forming apparatus using the same mechanism in which variation of the drive vectors acting on the teeth of the gear on the driven body is reduced so as to inhibit the wobble of the rotational axis of the driven body about the center and realize stable rotation free from irregularity.

In order to achieve the above object, the rotational drive transmission mechanism according to the present invention and the image forming apparatus including this are configured as follows:

The first aspect of the present invention resides in a rotational drive transmission mechanism including an internal gear and an external gear having involute tooth profiles for transmitting rotational drive force through the gears, characterized in that the internal gear is formed so that all the drive vectors of the rotational drive force transmitted to the teeth of either the internal gear or the external gear in mesh with the internal gear, are made uniform so as to be oriented either outwards from the center of the rotational axis or inwards toward the center of the rotational axis, equivalently relative to the center of the rotational axis.

Specifically, the teeth of the internal gears may be formed so that, when the teeth of the internal gear are put in contact with the external gear that meshes the internal gear, the drive vectors of the rotational drive force to be transmitted through the teeth from the internal gear to the external gear are directed in a uniform manner toward the center of the rotational axis.

Also, the teeth of the internal gears may be formed so that, when the teeth of the internal gear are put in contact with the external gear that meshes the internal gear, the drive vectors of the rotational drive force to be transmitted through the teeth from the external gear to the internal gear are directed outwards in a uniform manner from the center of the rotational axis.

In the second aspect of the present invention, it is preferred that the diameter of the tip circle of the internal gear coincides with the diameter of the reference circle.

In the third aspect of the present invention, it is preferred that the diameter of the tip circle of the internal gear is equal to or greater than the diameter of the reference circle, and smaller than the diameter of the tip circle of the external gear.

In the fourth aspect of the present invention, it is preferred that the diameter of the tip circle of the internal gear is greater than the diameter of the reference circle, and equal to or smaller than the average of the diameter of the reference circle and the diameter of the tip circle of the external gear.

In the fifth aspect of the present invention, it is preferred that the internal gear is the drive gear which transmits drive force.

In the sixth aspect of the present invention, it is preferred that the internal gear is the driven gear to which drive force is transmitted.

The seventh aspect of the present invention resides in an image forming apparatus comprising: a photoreceptor drum on which a toner image is formed based on an electrostatic latent image; a transfer belt which moves along the photoreceptor drum to transfer the toner image formed on the photoreceptor drum; and, a rotational drive transmission mechanism including an internal gear and an external gear having involute tooth profiles to transmit rotational drive force from a drive source, characterized in that the rotational drive transmission mechanism employs one of the above rotational drive transmission mechanisms.

In the eighth aspect of the present invention, it is preferred that the rotational drive transmission mechanism transfers rotational drive force to the photoreceptor drum.

In the ninth aspect of the present invention, it is preferred that the rotational drive transmission mechanism transfers rotational drive force to the transfer belt.

In the tenth aspect of the present invention, it is preferred that the rotational drive transmission mechanism is used as a coupling member disposed between a drive source and a driven body.

According to the first aspect of the present invention, variation of the drive vectors of drive force acting on the teeth of the gear on the driven side can be reduced so as to inhibit the wobble of the rotational axis of the driven body about its ideal center and realize rotation free from irregularity.

According to the second aspect of the present invention, the drive vectors of the rotational drive force transferred to the teeth can be made uniform to be directed either inwards to the center of the rotational axis side or outward from the center of the rotational axis.

According to the third aspect of the present invention, the drive vectors of the rotational drive force transferred to the teeth can be made uniform to be directed either inwards to the center of the rotational axis side or outward from the center of the rotational axis, and variation of the drive vectors can be reduced.

According to the fourth aspect of the present invention, it is possible to achieve stable drive transmission by reducing variation of the drive vectors of the rotational drive force transferred to the teeth and making reliable teeth engagement between the external gear and the internal gear.

According to the fifth aspect of the present invention, since the drive vectors of the rotational drive force transmitted to the external gear can be made uniform with respect to the center of rotation, it is possible to inhibit the wobble of the rotational axis of the external gear about its ideal center.

According to the sixth aspect of the present invention, since the drive vectors of the rotational drive force transmitted to the internal gear can be made uniform with respect to the center of rotation, it is possible to inhibit the wobble of the rotational axis of the internal gear about its ideal center.

According to the seventh aspect of the present invention, variation of the drive vectors of drive force acting on the gear on the driven side can be reduced so as to inhibit the wobble of the rotational axis of the driven body about its ideal center, whereby it is possible to improve image quality.

According to the eighth aspect of the present invention, it is possible to form toner images with high precision by inhibiting rotational irregularity of the photoreceptor drum.

According to the ninth aspect of the present invention, the transfer belt can be conveyed in a stable manner so that toner images can be transferred correctly.

According to the tenth aspect of the present invention, it is possible to realize exact rotation of the driven body by inhibiting its rotational irregularity.

### BRIEF DESCRIPTION OF THE DRAWINGS

FIG. 1 is an illustrative view showing a state in which a wobble of the rotational axis is occurring in a conventional drive transmission mechanism;

FIG. 2 is an illustrative view showing an overall configuration of an image forming apparatus including a rotational drive transmission mechanism according to the embodiment of the present invention;

FIG. 3 is an illustrative view showing one layout example of process units that constitute the image forming apparatus;

FIG. 4 is a perspective view showing the overall configuration of the process unit;

FIG. 5 is an illustrative view showing the internal configuration of the process unit;

FIG. 6 is an illustrative view showing a configuration of an intermediate transfer belt unit that constitutes the image forming apparatus;

FIG. 7 is an illustrative view showing the configuration of a driving mechanism including the rotational drive transmission mechanism;

FIG. 8 is an exploded illustrative view showing parts when the rotational drive transmission mechanism is separated from the driving mechanism.

FIG. 9A is an illustrative view showing the coupled state between a coupling member of a photoreceptor drum and a drive gear on the drive source side according to the present embodiment;

FIG. 9B is an illustrative view showing the coupled state between a coupling member of a photoreceptor drum and a drive gear on the drive source side according to prior art;

FIG. 10A is an illustrative view showing the coupled state between a coupling member of an intermediate transfer belt and a drive gear on the drive source side according to the present embodiment;

FIG. 10B is an illustrative view showing the coupled state between a coupling member of an intermediate transfer belt unit and a drive gear on the drive source side according to prior art; and,

FIG. 11 is a partially enlarged view showing a variational example of a drive gear (external gear) and a driven gear (internal gear) that constitute a rotational drive transmission mechanism of the embodiment according to the present invention.

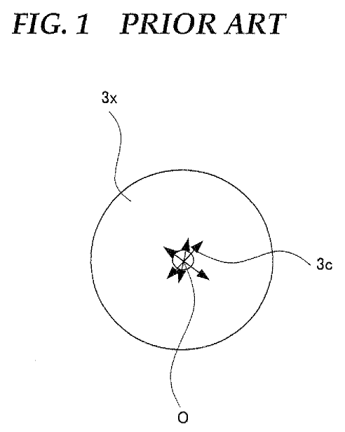

### DESCRIPTION OF THE PREFERRED EMBODIMENTS

The embodiment of the present invention will hereinafter be described in detail with reference to the accompanying drawings.

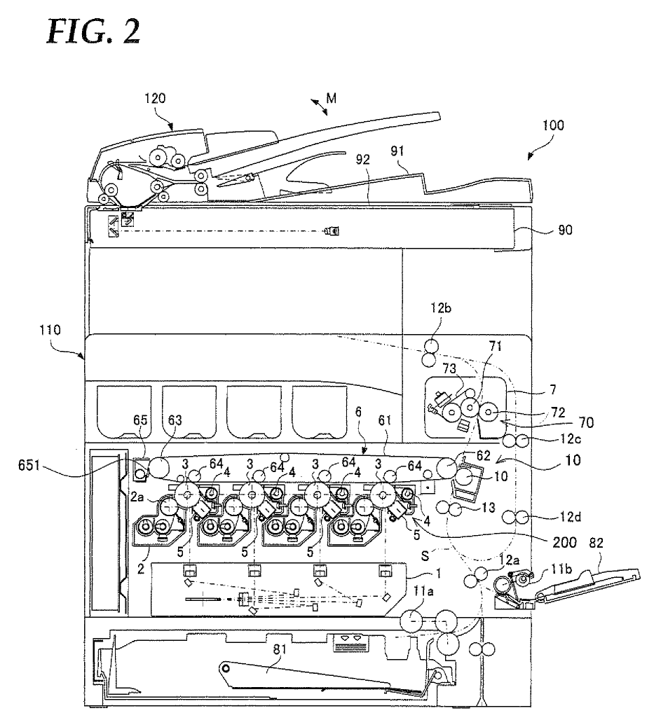

FIG. 2 is an illustrative view showing an overall configuration of an image Forming apparatus including a rotational drive transmission mechanism according to the embodiment of the present invention.

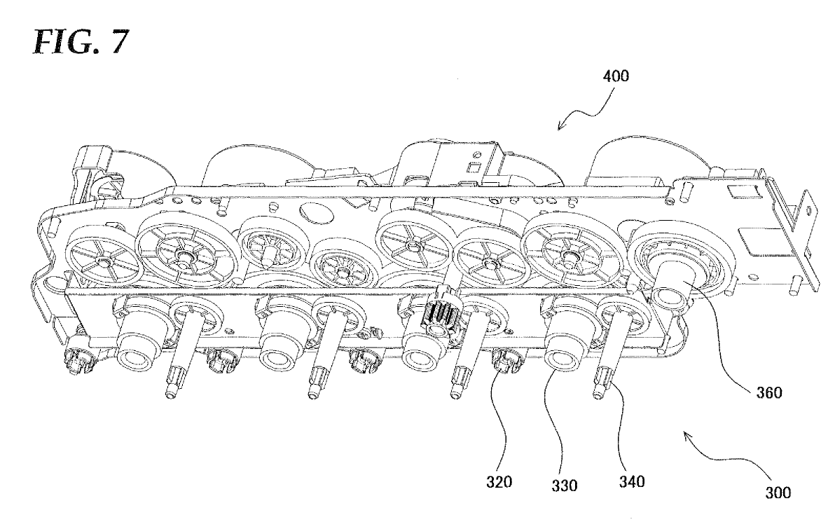

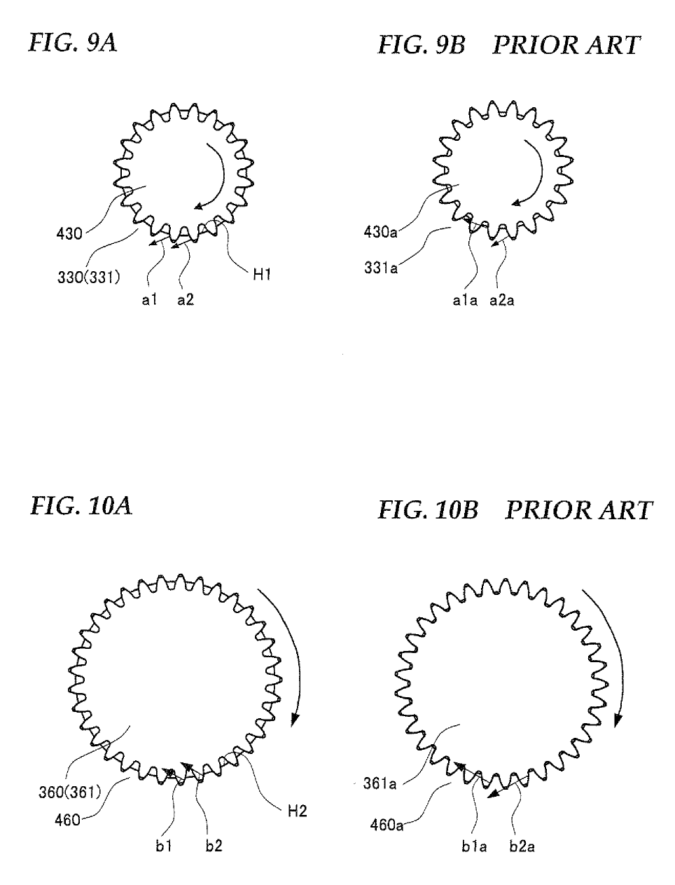

As shown in FIG. 2, an image forming apparatus 100 includes: photoreceptor drums 3 on which a toner image is formed based on an electrostatic latent image; an intermediate transfer belt (transfer belt) 61 which moves along the photoreceptor drums 3 to transfer the toner images formed on the photoreceptor drums 3; and a rotational drive transmission mechanism 300 (see FIGS. 7 and 9) including an internal gear and an external gear having involute tooth profiles to transmit rotational drive force from a drive source.

To begin with, the overall configuration of image forming apparatus 100 according to the present embodiment will be described.

As shown in FIG. 2, image forming apparatus 100 forms a multi-colored or monochrome image on a predetermined sheet (e.g., recording paper) in accordance with image data transmitted from an external device, and is mainly composed of a main apparatus body 110 and an automatic document processor 120.

Main apparatus body 110 includes: an exposure unit 1; developing units 2, photoreceptor drums 3, cleaner units 4, chargers 5, an intermediate transfer belt unit 6, a fusing unit 7, a paper feed cassette 81 and a paper output tray 91.

Arranged on top of main apparatus body 110 is a document table 92 made of a transparent glass plate on which a document is placed. On the top of document table 92, automatic document processor 120 is mounted. Arranged under document table 92 is a document reader (scanner portion) 90 for reading image information of a document.

Automatic document processor 120 automatically feeds documents onto document table 92.

This document processor 120 is constructed so as to be pivotable in the directions of bidirectional arrow M so that a document can be manually placed by opening the top of document table 92.

The image data handled in image forming apparatus 100 is data for color images of four colors, i.e., black (K), cyan (C), magenta (M) and yellow (Y).

Accordingly, four developing units 2, four photoreceptor drums 3, four chargers 5, four cleaner units 4 are provided to produce four electrostatic latent images corresponding to black, cyan, magenta and yellow. That is, four imaging stations are constructed thereby.

Exposure unit 1 corresponds to the image writing device, and is constructed as a laser scanning unit (LSU) having a laser emitter, reflection mirrors, etc. In this exposure unit 1, a polygon mirror for scanning a laser beam, optical elements such as lenses and mirrors for leading the laser beam reflected by the polygon mirror to photoreceptor drums 3 are laid out.

As exposure unit 1, other methods using an array of light emitting elements such as an EL or LED writing head, for example may be used instead.

The thus constructed exposure unit 1 has the function of illuminating each of the electrified photoreceptor drums 3 with light in accordance with the input image data to form an electrostatic latent image corresponding to the image data on the surface of each photoreceptor drum 3.

Developing unit 2 visualizes the electrostatic latent images formed on photoreceptor drums 3 with four color (Y, M, C and K) toners.

Photoreceptor drums 3 each have a cylindrical form and are disposed over exposure unit 1. The surface of each photoreceptor drum 3 is cleaned by cleaner unit 4 and then uniformly electrified by charger 5.

Cleaner unit 4 removes and collects the toner left over on the photoreceptor drum 3 surface after development and image transfer.

Charger 5 is the charging portion for uniformly electrifying the photoreceptor drum 3 surface at a predetermined potential. Other than the corona-discharge type chargers shown in FIG. 2, contact type chargers, i.e., roller type or brush type charger may also be used.

The photoreceptor drum 3, cleaner unit 4 and charge 5 constitutes a process unit 200. This process unit 200 has a rotatory operational mechanism for receiving drive force from a rotational drive transmission mechanism 300 (see FIG. 7).

Intermediate transfer belt unit 6 arranged over photoreceptor drums 3 is comprised of an intermediate transfer belt 61, an intermediate transfer belt drive roller 62, an intermediate transfer belt driven roller 63, four intermediate transfer rollers 64 corresponding to four YMCK colors and an intermediate transfer belt cleaning unit 65.

Intermediate transfer belt drive roller 62, intermediate transfer belt driven roller 63 and intermediate transfer rollers 64 are arranged so as to support and tension intermediate transfer belt 61 and circulatively drive the belt.

Intermediate transfer belt 61 is an endless film of about 100 μm to 150 μm thick and is arranged so as to contact with each photoreceptor drum 3. The toner images of different colors formed on photoreceptor drums 3 are sequentially transferred in layers to intermediate transfer belt 61, forming a color toner image (multi-color toner image) on intermediate transfer belt 61.

Transfer of toner images from photoreceptor drums 3 to intermediate transfer belt 61 are performed by intermediate transfer rollers 64 that are in contact with the rear side of intermediate transfer belt 61.

Each intermediate transfer roller 64 is adapted to apply a transfer bias to intermediate transfer belt 61 to transfer the toner image on photoreceptor drum 3 onto intermediate transfer belt 61. Detailedly, a high-voltage transfer bias (high voltage of a polarity (+) opposite to the polarity (−) of the static charge on the toner) is applied to intermediate transfer roller 64 in order to transfer the toner image.

Intermediate transfer roller 64 is a roller that is formed of a base shaft made of metal (e.g., stainless steel) having a diameter of 8 to 10 mm and a conductive elastic material (e.g., EPDM, foamed urethane or the like) coated on the shaft surface. This conductive elastic material enables uniform application of a high voltage to intermediate transfer belt 61. Though the transfer electrodes in the form of rollers are used in the present embodiment, brushes and the like can also be used instead of intermediate transfer rollers 64.

The visualized toner images of colors on different photoreceptor drums 3 are laid over one to the next on intermediate transfer belt 61 as stated above. The thus laminated toner image as the image information is conveyed as intermediate transfer belt 61 moves, and is transferred to the sheet being separately conveyed, by a transfer roller 10a that is arranged at the contact position between intermediate transfer belt 61 and the sheet.

In this process, intermediate transfer belt 61 and transfer roller 10a are pressed against each other forming a predetermined nip while a voltage for transferring the toner to the paper (a high voltage of a polarity (+) opposite to the polarity (−) of the static charge on the toner) is applied to transfer roller 10a.

In order to constantly obtain the predetermined nip between intermediate transfer belt 61 and transfer roller 10a, either transfer roller 10a or intermediate transfer belt drive roller 62 is formed of a hard material (metal or the like) while the other is formed of a soft material such as an elastic roller or the like (elastic rubber roller, foamed resin roller etc.).

Since, in the aforementioned transfer stage, the toner adhering to intermediate transfer belt 61 as the belt comes in contact with photoreceptor drums 3, or the toner which has not been transferred by transfer roller 10a to the sheet and remains on intermediate transfer belt 61, would cause color contamination of toners in the toner image formed at the next operation, the remaining toner is adapted to be removed and collected by intermediate transfer belt cleaning unit 65.

Intermediate transfer belt cleaning unit 65 is arranged at a position, along the path in which intermediate transfer belt 61 is conveyed, downstream of transfer roller 10a and upstream of photoreceptor drums 3 with respect to the intermediate transfer belt's direction of movement.

Intermediate transfer belt cleaning unit 65 includes a cleaning blade 651 as a cleaning member that comes in contact with intermediate transfer belt 61 and clean the surface of intermediate transfer belt 61. Intermediate transfer belt 61 is supported from its interior side by intermediate transfer belt driven roller 63r at the portion where this cleaning blade 651 comes into contact with the belt.

Paper feed cassette 81 is a tray for stacking sheets to be used for image forming and is arranged under exposure unit 1 of main apparatus body 110. Also, a manual paper feed cassette 82 that permits sheets to be supplied from without is arranged outside main apparatus body 110.

This manual paper feed cassette 82 can also hold a plurality of sheets to be used for image forming. Arranged in the upper part of main apparatus body 110 is a paper output tray 91 which collects printed sheets facedown.

Main apparatus body 110 further includes a paper feed path S that extends approximately vertically to convey the sheet from paper feed cassette 81 or manual paper feed cassette 82 to paper output tray 91 by way of transfer roller 10a and fusing unit 7. Arranged along paper feed path S from paper feed cassette 81 or manual paper feed cassette 82 to paper output tray 91 are pickup rollers 11a and 11b, a plurality of feed rollers 12a to 12d, a registration roller 13, transfer roller 10a, fusing unit 7 and the like.

Feed rollers 12a to 12d are small rollers for promoting and supporting conveyance of sheets and are arranged along paper feed path S.

Pickup roller 11a is arranged near the end of paper feed cassette 81 so as to pick up one sheet at a time from paper feed cassette 81 and deliver it to paper feed path S.

Pickup roller 11b is arranged near the end of manual paper feed cassette 82 so as to pick up one sheet at a time from manual paper feed cassette 82 and deliver it to paper feed path S.

Registration roller 13 temporarily suspends the sheet that is conveyed along paper feed path S. This roller has the function of delivering the sheet toward transfer roller 10a at such a timing that the front end of the paper will meet the front end of the image area on photoreceptor drums 3 (intermediate transfer belt 61.

Fusing unit 7 includes a heat roller 71 and a pressing roller 72 as fusing rollers 70. Heat roller 71 and pressing roller 72 are arranged so as to rotate and convey the sheet while nipping it therebetween.

Further, heat roller 71 is adapted to be set at a predetermined fusing temperature by the controller in accordance with the signal from an unillustrated temperature detector, and has the function of heating and pressing the toner to the sheet in cooperation with pressing roller 72, so as to thermally fix the multi-color toner image transferred on the sheet to the sheet by fusing, mixing and pressing it. The fusing unit further includes an external heating belt 73 for heating heat roller 71 from without.

Next, the sheet feed path in image forming apparatus 100 will be described.

As shown in FIG. 2, image forming apparatus 100 has paper feed cassette 81 for storing sheets beforehand and manual paper feed cassette 82. In order to deliver sheets from these paper feed cassettes 81 and 82, pickup rollers 11a and 11b are arranged so as to deliver one sheet at a time to paper feed path S.

The sheet delivered from paper feed cassettes 81 or 82 is conveyed by feed rollers 12a on paper feed path S to registration roller 13, by which the sheet is released toward transfer roller 10a at such a timing that the front end of the sheet meets the front end of the image information on intermediate transfer belt 61 so that the image information is transferred to the sheet. Thereafter, the sheet passes through fusing unit 7, whereby the unfixed toner on the sheet is fused by heat and fixed. Then the sheet is discharged through feed rollers 12b onto paper output tray 91.

The paper feed path described above is that of the sheet for a one-sided printing request.

On the other hand, when a duplex printing request is given, the sheet with its one side printed passes through fusing unit 7 and is held at its rear end by feed roller 12b, then the feed roller 12b rotates in reverse so as to lead the sheet toward feed rollers 12c and 12d. Thereafter, the sheet passes through registration roller 13 and is printed on its rear side and discharged onto paper output tray 91.

Next, process unit 200 that characterizes the present embodiment will be described in detail with reference to the drawings.

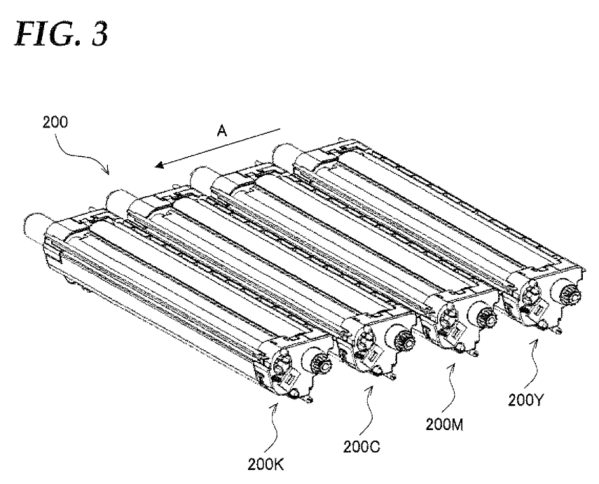

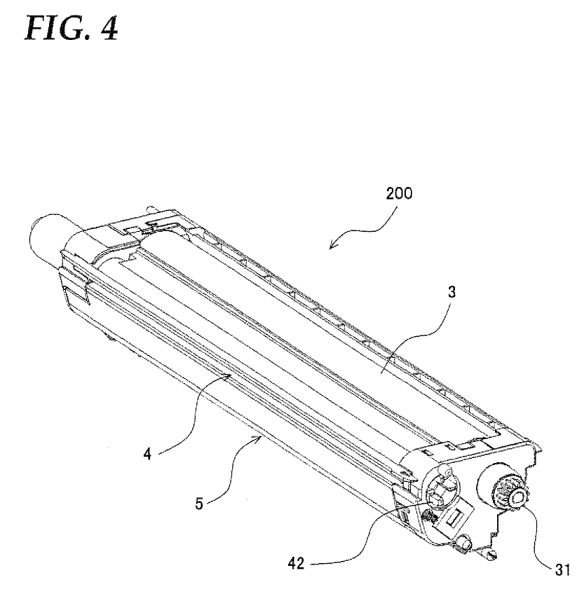

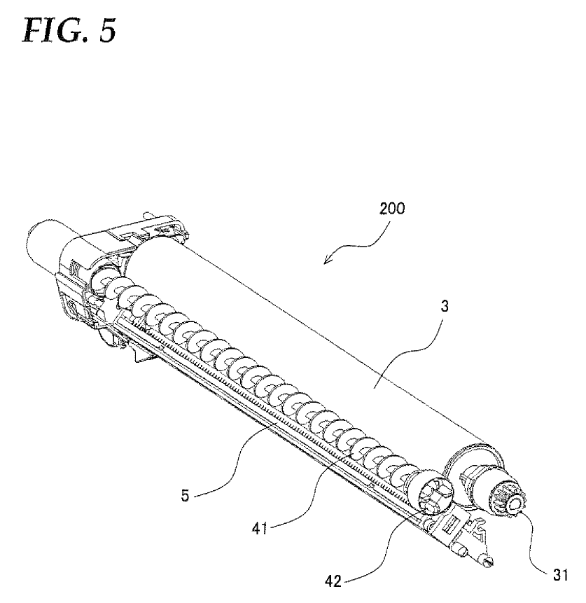

FIG. 3 is an illustrative view showing one Layout example of process units that constitute an image forming apparatus according to the present embodiment. FIG. 4 is a perspective view showing an overall configuration of the process unit. FIG. 5 is an illustrative view showing the internal configuration of the process unit.

Process units 200 of the present embodiment are arranged as shown in FIG. 3 so that process unit 200Y, process unit 200M, process unit 200C and process unit 200K are arranged from one to the next, correspondingly to Y, M, C and K colors, along the direction of sheet conveyance (in the direction of arrow A) from the upstream side. In the description hereinbelow, any of the process unit will be designated at 200 when general mention is made.

In process unit 200, in order to transmit driving force to photoreceptor drum 3 and cleaner unit 4, as shown in FIG. 4, a drum gear (external gear) 31 for transferring rotational drive force to photoreceptor drum 3 and a cleaning screw coupling 42 for transferring rotational drive force to a waste toner conveying screw 41 (FIG. 5) disposed in cleaner unit 4 are provided as shown in FIG. 4.

Drum gear 31 has an involute tooth profile and is disposed at one end of photoreceptor drum 3. Cleaning screw coupling 42 is arranged at one end of waste toner conveying screw 41. This drum gear 31 and cleaning screw coupling 42 are disposed on the same flank of process unit 200.

As shown in FIG. 5, inside process unit 200, waste toner conveying screw 41 for conveying collected waste toner is arranged along and adjacent to photoreceptor drum 3 so that its axial direction of extension (which will be referred to hereinbelow as “axial direction”) is parallel to the axial direction of photoreceptor drum 3. Charger 5 is arranged under waste toner conveying screw 41.

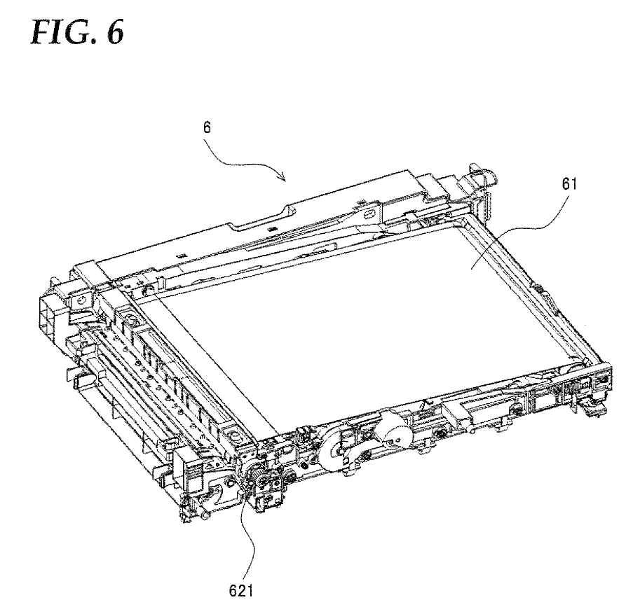

Next, intermediate transfer belt unit 6 that characterizes the present embodiment will be described in detail with reference to the drawing. FIG. 6 is an illustrative view showing the configuration of an intermediate transfer belt unit that constitutes an image forming apparatus according to the present embodiment.

Intermediate transfer belt unit 6 of the present embodiment is provided with a transfer drive gear (external gear) 621 for driving intermediate transfer belt drive roller 62 (FIG. 2) for conveying intermediate transfer belt 61, as shown in FIG. 6. This transfer drive gear 621 has an involute tooth profile, and is arranged at one end of intermediate transfer belt drive roller 62. Transfer drive gear 621 and the aforementioned drum gear 31 and cleaning screw coupling 42 are arranged on the same side in the image forming apparatus body.

Next, rotational drive transmission mechanism 300 that characterizes the present embodiment will be described in detail with reference to the drawings.

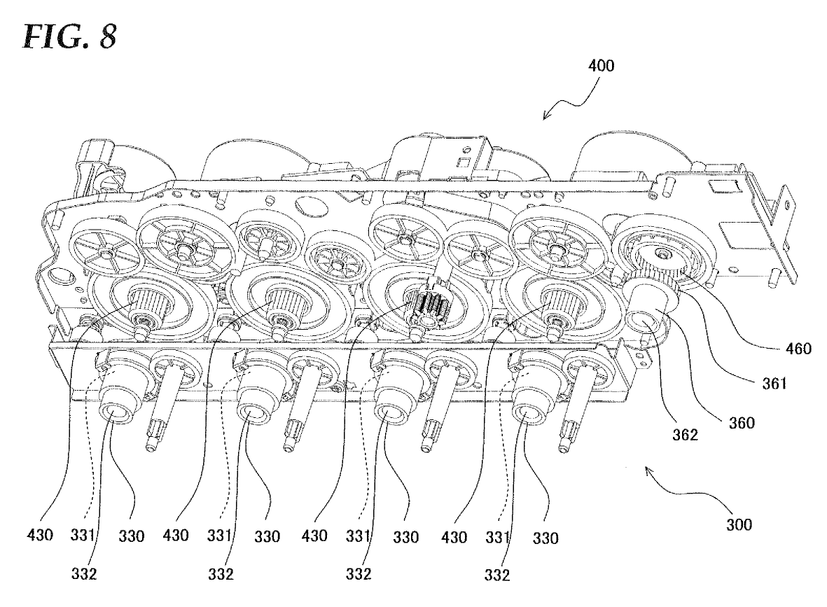

FIG. 7 is an illustrative view showing the configuration of a driving mechanism including a rotational drive transmission mechanism according to the present embodiment. FIG. 8 is an exploded illustrative view showing parts when the rotational drive transmission mechanism is separated from the driving mechanism.

As shown in FIG. 7, rotational drive transmission mechanism 300 of the present embodiment constitutes part of a driving mechanism 400 for driving the moving components inside the apparatus, and transmits drive force from an unillustrated drive source to each moving component.

In the present embodiment, rotational drive transmission mechanism 300 includes: as shown in FIG. 7, photoreceptor drum drive couplings (coupling members) 330 for transferring rotational drive force to each photoreceptor drum 3; a transfer drive coupling (coupling member) 360 for transmitting rotational drive force to intermediate transfer belt drive roller 62; developing hopper drive couplings 320 for transmitting rotational drive force to each developing unit 2; and waste toner conveying screw driving gears 340 for transmitting rotational drive force to each cleaner unit 4.

Developing hopper drive coupling 320 is coupled with an unillustrated engaging portion of developing unit 2 so as to transfer rotational drive force to the developing roller and agitating roller.

Waste toner conveying screw driving gear 340 is coupled with cleaning screw coupling 42 shown in FIG. 5 so as to transfer rotational drive force to waste toner conveying screw 41.

Now, the characteristic configurations of photoreceptor drum drive coupling 330 and transfer drive coupling 360 will be described in detail.

Photoreceptor drum drive coupling 330 is constructed as shown in FIG. 8, such that a first gear (internal gear) 331 to be the driven side that is coupled with a drive gear (external gear) 430 for transmitting rotational drive force from drive mechanism 400 is formed at its one end while a second gear (internal gear) 332 to be the drive side that coupled with drum gear 31 (FIG. 5) is formed at the other end. That is, photoreceptor drum drive coupling 330 is disposed between the drive source and drum gear 31 so as to transmit the rotational drive force from the former to the latter.

Any of first gear 331, second gear 332, drum gear 31 and drive gear 430 has an involute tooth profile. In particular, internal teeth H1 (FIG. 9A) of first gear 331 are formed so that the diameter of the tip circle coincides with the diameter of the reference circle. That is, the top of the teeth corresponds to the reference circle.

Transfer drive coupling 360 is constructed as shown in FIG. 8, such that a first gear (external gear) 361 to be the driven side that is coupled with a drive gear (internal gear) 460 for transmitting rotational drive force from drive mechanism 400 is formed at its one end while a second gear (internal gear) 362 to be the drive side that is coupled with transfer drive gear (external gear) 621 (FIG. 6) of intermediate transfer belt unit 6 is formed at the other end. That is, transfer drive coupling 360 is disposed between the drive source and transfer drive gear 621 so as to transmit the rotational drive force from the former to the latter.

Any of first gear 361, second gear 362, drive gear 460 and transfer drive gear 621 has an involute tooth profile. In particular, internal teeth H2 (FIG. 10A) of drive gear 460 are formed so that the diameter of the tip circle coincides with the diameter of the reference circle.

These photoreceptor drum drive couplings 330 and transfer drive coupling 360 are loosely fitted to the drive side gears of drive mechanism 400 and interposed between drum gears 31 (FIG. 5) of process units 200 each positioned to the image forming apparatus body and their drive sources (drive gears 430) and between transfer drive gear 621 (FIG. 6) of intermediate transfer belt unit 6 positioned to the image forming apparatus body and its drive source (460), so as to absorb slight positional deviation of each driven member to its drive source, explicitly, slight positional deviations of photoreceptors 3 and intermediate transfer belt 61.

Next, the operation of rotational drive transmission mechanism 300 characterizing the present embodiment will be described in detail with reference to the drawings.

FIG. 9A is an illustrative view showing the coupled state between the coupling member of the photoreceptor drum and the drive gear on the drive source side according to the present embodiment. FIG. 9B is an illustrative view showing the coupled state between the coupling member of a photoreceptor drum and the drive gear on the drive source side according to prior art. FIG. 10A is an illustrative view showing the coupled state between the coupling member of the intermediate transfer belt unit and the drive gear on the drive source side according to the present embodiment. FIG. 10B is an illustrative view showing the coupled state between the coupling member of an intermediate transfer belt unit and the drive gear on the drive source side according to prior art.

To begin with, the case for driving photoreceptor drum 3 will be described.

In the present embodiment, when drive from rotational drive transmission mechanism 300 is transmitted to photoreceptor drum 3, as shown in FIGS. 9A and 8, rotational drive force is transmitted from drive gear 430 of drive mechanism 400 to photoreceptor drum 3 by way of photoreceptor drum drive coupling 330.

In the present embodiment, as shown in FIG. 9A, internal teeth H1 of first gear 331 on the driven side are formed so that the diameter of the tip circle coincides with the diameter of the reference circle.

When rotational drive force is transferred from drive gear 430 to first gear 331 of photoreceptor drum drive coupling 330, the rotational drive force from drive gear 430, as shown in FIG. 9A, acts on only the dedendums of first gear 331, which are located outside the reference circle of internal teeth H1, centered by the common rotational axis of drive gear 430 and first gear 331. Accordingly, the drive vectors of the rotational drive force acting or first gear 331 result in drive vectors a1, a2 . . . , which are oriented outwards from the center of the rotational axis of photoreceptor drum coupling 330, in an equivalent manner.

Here, in the conventional configuration for transferring rotational drive force to photoreceptor drum 3, as shown in FIG. 9B, drive gear 430a and first gear 331a having involute tooth profiles are formed so that the diameter of the tip circle of the internal teeth of first gear 331a on the driven side is greater than the diameter of reference circle. As a result, when rotational drive force is transferred from drive gear 430a to first gear 331a on the photoreceptor drum 3 side, the drive vectors vary (become different) depending on the contact point between the teeth of drive gear 430a and first gear 331a. That is, drive vectors ala that are oriented inwards to the center of the rotational axis acts on the addendums of first gear 331a, which are located inside the reference circle of internal teeth of first gear 331a that is centered by the common rotational axis of drive gear 430a and first gear 331a while drive vectors a2a that are oriented outwards from the center of the rotational axis act on dedendums of first gear 331a that are located outside the reference circle.

In the present embodiment, as shown in FIG. 9A, internal teeth H1 of first gear 331 on the driven side are formed so that the diameter of the tip circle coincides with the diameter of the reference circle. Accordingly, the drive vectors acting on all the teeth of first gear 331 are equivalently directed outwards from the center of the rotational axis, hence it is possible to inhibit photoreceptor drum drive coupling 330 from wobbling due to variation of the drive vectors in first gear 331.

As a result, it is possible to inhibit the wobble of the rotational axis of photoreceptor drum 3 that is coupled to photoreceptor drum drive coupling 330 with respect to the center of photoreceptor drum 3, hence improve image quality.

Next, the case for driving intermediate transfer belt unit 6 will be described.

In the present embodiment, when drive from rotational drive transmission mechanism 300 is transmitted to intermediate transfer belt unit 6, as shown in FIGS. 10A and 8, rotational drive force is transmitted from drive gear 460 of drive mechanism 400 to transfer drive gear 621 (FIG. 6) of intermediate transfer belt unit 6 by way of transfer drive coupling 360.

In the present embodiment, as shown in FIG. 10A, internal teeth H2 of drive gear 460 on the drive side are formed so that the diameter of the tip circle coincides with the diameter of the reference circle.

When rotational drive force is transferred from drive gear 460 to first gear 361 of transfer drive coupling 360, the rotational drive force from drive gear 460, as shown in FIG. 10A, acts on only the dedendums of drive gear 460, which are located outside the reference circle of internal teeth H2 that is centered by the common rotational axis of drive gear 460 and first gear 361 on the driven side. Accordingly, the drive vectors of the rotational drive force acting on first gear 361 result in drive vectors b1, b2 . . . , which are oriented inwards to the center of the rotational axis of transfer drive coupling 360, in an equivalent manner.

Here, in the conventional configuration for transferring rotational drive force to intermediate transfer belt unit 6, as shown in FIG. 10B, drive gear 460a and first gear 361a having involute tooth profiles are formed so that the diameter of the tip circle of the internal teeth of drive gear 460a is smaller than the diameter of reference circle. As a result, when rotational drive force is transferred from drive gear 460a to first gear 361a on the intermediate transfer belt unit 6 side, the drive vectors vary (become different) depending on the contact point between the teeth of drive gear 460a and first gear 361a. That is, drive vectors b1a that are oriented inwards to the center of the rotational axis act on the dedendums of drive gear 460a, which are located outside the reference circle of internal teeth of drive gear 460a that is centered by the common rotational axis of drive gear 460a and first gear 361a while drive vectors b2a that are oriented outwards from the center of the rotational axis act on addendums of drive gear 460a that are located inside the reference circle.

In the present embodiment, as shown in FIG. 10A, internal teeth H2 of drive gear 460 on the drive side are formed so that the diameter of the tip circle coincides with the diameter of the reference circle. Accordingly, the drive vectors transferred from all the teeth of drive gear 460 are equivalently directed inwards to the center of the rotational axis, hence it is possible to inhibit transfer drive coupling 360 from wobbling due to variation of the drive vectors in first gear 361.

As a result, it is possible to inhibit the wobble with respect to the axial center of intermediate transfer belt drive roller 62 that is coupled to transfer drive coupling 360, hence intermediate transfer belt drive roller 62 can be rotated free from deviation so as to convey intermediate transfer belt 61 stably to thereby improve quality of transferred images.

According to the present embodiment thus constructed as above, in image forming apparatus 100, provision of photoreceptor drum drive coupling 330 and transfer drive coupling 360, which characterize the configuration of the present invention, as rotational drive transmission mechanism 300 for transmitting rotational drive force, makes it possible to inhibit wobbles, which would occur when rotational drive force is transferred to photoreceptor drums 3 and to intermediate transfer belt roller 62 of intermediate transfer belt unit 6.

As a result, it is possible in image forming apparatus 100 to improve the quality of toner images formed on photoreceptor drums 3, and also to improve the quality of transferred image because intermediate transfer belt drive roller 62 can be rotated free from deviation so as to convey intermediate transfer belt 61 stably.

According to the present embodiment, since the internal gears (first gear (internal gear) 331 of photoreceptor drum drive coupling 330 and drive gear (internal gear) 460 for transferring rotational force of drive mechanism 400) used in rotational drive transmission mechanism 300 are constructed so that the tip circles of the internal teeth H1 and H2 coincide with the diameters of the respective reference circles, it is possible to direct the drive vectors of the rotational drive force acting on the gears on the driven side in the uniform direction with respect to the center, hence it is possible to inhibit the wobbles of the driven bodies resulting from drive transmission.

Here, it is possible to arbitrarily select either the internal gear or the external gear as the drive-side one or the driven-side one.

Next, a variational example of the above embodiment will be described with reference to the drawing.

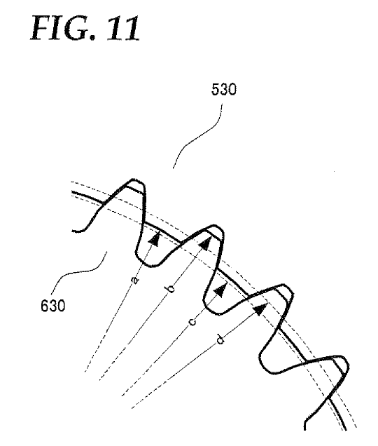

FIG. 11 is a partially enlarged view showing a variational example of the drive gear (external gear) and driven gear (internal gear) that constitute a rotational drive transmission mechanism of the embodiment according to the present invention.

This example is a variation of the above configuration where drive gear (external gear) 430 for transmitting rotational drive force in rotational drive transmission mechanism 300 and the driven-side first gear (internal gear) 331 are coupled to each other. Specifically, a drive side gear (external gear) 630 and a driven side gear (internal gear) 530 are put in mesh with each other, as shown in FIG. 11.

Based on the common rotational axis of drive side gear 630 and driven side gear 530, the diameter of the tip circle of driven side gear 530 is equal to or greater than the diameter of the reference circle and smaller than the diameter of the tip circle of drive side gear 630. Explicitly, these gears are specified, as shown in FIG. 11, so that the diameter ‘a’ of the tip circle of driven side gear 530 is 16.2 (mm) the diameter ‘b’ of the tip circle of drive side gear 630 is 17.6 (mm) and the diameter ‘c’ of the reference circle is 16.0 (mm). The average ‘d’ of the diameter ‘b’ of the tip circle of drive side gear 630 and the diameter ‘c’ of the reference circle is 16.8 (mm).

In sum, the diameter ‘a’ of the tip circle of driven side gear 530 is greater than the diameter ‘c’ of the reference circle and equal to or smaller than the average ‘d’ of the diameter ‘c’ of the reference circle and the diameter ‘b’ of the tip circle of drive side gear 630.

According to this variational example thus constructed, since the diameter ‘a’ of the tip circle of driven side gear 530 is marginally greater, by 0.2 mm, than the diameter ‘c’ of the reference circle, it is possible to improve the effect of reducing the variation of the drive vectors compared to the above-described embodiment. Further, since the diameter ‘a’ of the tip circle of driven side gear 530 is smaller by 1.4 mm than the diameter ‘b’ of the tip circle of drive side gear 630, it is possible to reliably transfer the drive.

Further, in the variational example, since the diameter ‘a’ (φ16.2) of the tip circle of driven side gear 530 is configured to be smaller than the average ‘d’ (φ16.8) of the diameter ‘c’ of the reference circle and the diameter ‘b’ of the tip circle of drive side gear 630, it is possible to perform reliable and stable drive transmission even if a large drive torque acts. In contrast, if the diameter ‘a’ of the tip circle of driven side gear 530 exceeds the average ‘d’ (φ16.8), the risk of the teeth jumping becomes higher.

Accordingly, it is preferred that the diameter ‘a’ (φ16.2) of the tip circle of driven side gear 530 is marginally greater than the diameter ‘c’ (φ16.0) of the reference circle and smaller than the average ‘d’ (φ16.8).

Having described the preferred embodiment and variational example of the present invention, it goes without saying that the present invention should not be limited to the above-described examples, and it is obvious that various changes and modifications will occur to those skilled in the art within the scope of the appended claims. Such variations are therefore understood to be within the technical scope of the present invention.

For example, in the above embodiment, the present invention is applied to a color image forming apparatus, however the present invention can also be applied to a monochrome image forming apparatus including a rotational drive transmission mechanism. Further, as long an apparatus including a drive transmission mechanism corresponding to a rotational drive transmission mechanism, it is possible to develop the apparatus by applying the rotational drive transmission mechanism of the present invention to the apparatus.

1. A rotational drive transmission mechanism including an internal gear and an external gear having involute tooth profiles for transmitting rotational drive force through the gears, characterized in that
the internal gear is formed so that all the drive vectors of the rotational drive force transmitted to the teeth of either the internal gear or the external gear in mesh with the internal gear, are made uniform so as to be oriented either outwards from the center of the rotational axis or inwards toward the center of the rotational axis, equivalently relative to the center of the rotational axis.

2. A rotational drive transmission mechanism including an internal gear and an external gear having involute tooth profiles for transmitting rotational drive force through the gears, characterized in that
the diameter of the tip circle of the internal gear coincides with the diameter of the reference circle.

3. A rotational drive transmission mechanism including an internal gear and an external gear having involute tooth profiles for transmitting rotational drive force through the gears, characterized in that
the diameter of the tip circle of the internal gear is equal to or greater than the diameter of the reference circle, and smaller than the diameter of the tip circle of the external gear.

4. The rotational drive transmission mechanism according to claim 3, wherein the diameter of the tip circle of the internal gear is greater than the diameter of the reference circle, and equal to or smaller than the average of the diameter of the reference circle and the diameter of the tip circle of the external gear.

5. The rotational drive transmission mechanism according to claim 1, wherein the internal gear is the drive gear which transmits drive force.

6. The rotational drive transmission mechanism according to claim 1, wherein the internal gear is the driven gear to which drive force is transmitted.

7. An image forming apparatus comprising:
a photoreceptor drum on which a toner image is formed based on an electrostatic latent image;
a transfer belt which moves along the photoreceptor drum to transfer the toner image formed on the photoreceptor drum; and,
a rotational drive transmission mechanism including an internal gear and an external gear having involute tooth profiles to transmit rotational drive force from a drive source,
characterized in that the rotational drive transmission mechanism employs one of the rotational drive transmission mechanisms defined in claim 1.

8. The image forming apparatus according to claim 7, wherein the rotational drive transmission mechanism transfers rotational drive force to the photoreceptor drum.

9. The image forming apparatus according to claim 7, wherein the rotational drive transmission mechanism transfers rotational drive force to the transfer belt.

10. The image forming apparatus according to claim 7, wherein the rotational drive transmission mechanism is used as a coupling member disposed between a drive source and a driven body.
